(19) United States
(12) Patent Application Publication
(10) Pub. No.: US 2013/0270014 A1
(43) Pub. Date: Oct. 17, 2013

(54) INTELLIGENT WEIGHT MONITORING SYSTEM AND METHOD THEREOF

(71) Applicants: METAL INDUSTRIES RESEARCH & DEVELOPMENT CENTRE, Kaohsiung City (TW); CHANG GUNG UNIVERSITY, Taoyuan County (TW)

(72) Inventors: CHANG-MING HU, KAOHSIUNG CITY (TW); MIN-YIH LEE, TAOYUAN COUNTY (TW); CHENG-YAO LIN, KAOHSIUNG CITY (TW); SUNG-LIANG HSIEH, KAOHSIUNG CITY (TW); HSIU-PIN WANG, KAOHSIUNG CITY (TW); CHIEN-MING HSU, KAOHSIUNG CITY (TW); TSUNG-YI LIN, KAOHSIUNG CITY (TW)

(73) Assignees: CHANG GUNG UNIVERSITY, TAOYUAN COUNTY (TW); METAL INDUSTRIES RESEARCH & DEVELOPMENT CENTRE, KAOHSIUNG CITY (TW)

(21) Appl. No.: 13/690,613

(22) Filed: Nov. 30, 2012

(30) Foreign Application Priority Data
Apr. 11, 2012 (TW) 101112723

(51) Int. Cl. G01G 19/00

(52) U.S. Cl. CPC G01G 19/00
USPC 177/1; 177/45

(57) ABSTRACT

The present invention relates to an intelligent weight monitoring system and the method thereof. The system comprises a weight monitoring module, a signal processing module, and a comparison module. The weight measuring module measures at least a weight of a sickbed having a patient, and produces and transmits at least a signal according to the measured weight. The signal processing module processes the signal for producing and transmitting physiological data to the comparison module. The comparison module judges if the patient is abnormal according to the physiological data for producing an abnormal signal. The patient's family members or nurses can get the abnormal signal produced by the comparison module real-timely. Thereby, appropriate medical measures can be applied according to the abnormal signal.

### FIELD OF THE INVENTION

The present invention relates generally to a weight monitoring system and the method thereof, and particularly to an intelligent weight monitoring system and the method thereof for monitoring a patient's condition.

### BACKGROUND OF THE INVENTION

The weight of a bedridden patient with certain symptoms such as dehydration or requiring dialysis needs to be measured frequently for mastering his health conditions real-timely. The measured data can even be used for determining if immediate medical actions should be exercised. Under such circumstances, the patient usually cannot move by himself. In addition, for avoiding influence the patient, nurses cannot move the patient's body. How to measure the weight of this kind of patient has become an important subject. Currently, by using a bed weight scale, the purpose of measuring a patient's weight without moving him can be achieved.

In addition to knowing the weight variation of a patient, it does not make sense without applying the corresponding actions. The Taiwan patent number 1272514 entitled “Interactive medical information method” mainly provides a patient with a physiological data-measuring device capable of connecting to multiple physiological signal sensors. Thereby, the patient can measure various physiological data anytime and anywhere. By connecting the physiological data-measuring device to the Internet directly, the measured various physiological data are transmitted to the remote medical information system. Then, under the assistance of the medical information system, the nurses can access the user's personal data and various physiological data anytime for analyzing, judging and storing the results and health recommendations back to the medical information system. The user can connect to the medical information system via the physiological data-measuring device and inquire the analyzed results, which include his physiological data, histogram of the physiological data, and the health recommendations provided by the medical personnel. Hence, medical treatment can be performed according to his health condition. Nonetheless, this patent transmits messages only for the patient; no corresponding response occurs. The patient still need to act on his own for the medical process. Thereby, for bedridden patients, this patent is practical.

In order to solve the problem described above, the present invention provides an intelligent weight monitoring system and the method thereof. The present invention lets the patient's family members or nurses know abnormal conditions of the patient real-timely. Then the patient's family members or the nurses can perform appropriate medical measures immediately.

### SUMMARY

An objective of the present invention is to provide an intelligent weight monitoring system and the method thereof. Thereby, the patient's family members or nurses can know abnormal conditions of the patient real-timely. Then the patient's family members or the nurses can perform appropriate medical measures immediately.

The present invention provides an intelligent weight monitoring system, which comprises a weight measuring module, a signal processing module, and a comparison module. The weight measuring module measures at least a weight of a sickbed having a patient, and produces and transmits at least a signal according to the measured weight. The signal processing module receives and processes the signal for producing and transmitting physiological data. The comparison module receives the physiological data and judges if the patient is abnormal according to the physiological data for producing an abnormal signal.

The present invention provides an intelligent weight monitoring method, which comprises steps of providing a weight measuring module, where the weight measuring module measures at least a weight of a sickbed having a patient, and produces and transmits at least a signal to a signal processing module according to the measured weight; the signal processing module calculates the patient's location of center of gravity according to the signal, and produces and transmits physiological data according to the patient's location of center of gravity to a comparison module; and the comparison module judges if the patient is abnormal according to the physiological data for producing an abnormal signal.

### BRIEF DESCRIPTION OF THE DRAWINGS

FIG. 1 shows a system block diagram according to a first embodiment of the present invention;

FIG. 2 shows a flowchart according to the first embodiment of the present invention;

FIG. 3 shows an elaborate block diagram according to the first embodiment of the present invention;

FIG. 4 shows a system block diagram according to a second embodiment of the present invention;

FIG. 5 shows a system block diagram according to a third embodiment of the present invention;

FIG. 6 shows a schematic diagram of the danger zone for center of gravity according to the third embodiment of the present invention; and

FIG. 7 shows a schematic diagram of the distribution data for center of gravity according to the third embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

The physiological data measurement devices according to the prior art can only measure a patient's physiological data, which are transmitted back to the medical information system for analyzing and judging. When the medical information system judges that the patient's physiological condition is abnormal, appropriate medical measures cannot be applied to the patient immediately, which may result in miss of the prime time for therapy. The present invention provides an intelligent weight monitoring system and the method thereof for improving the problem described above.

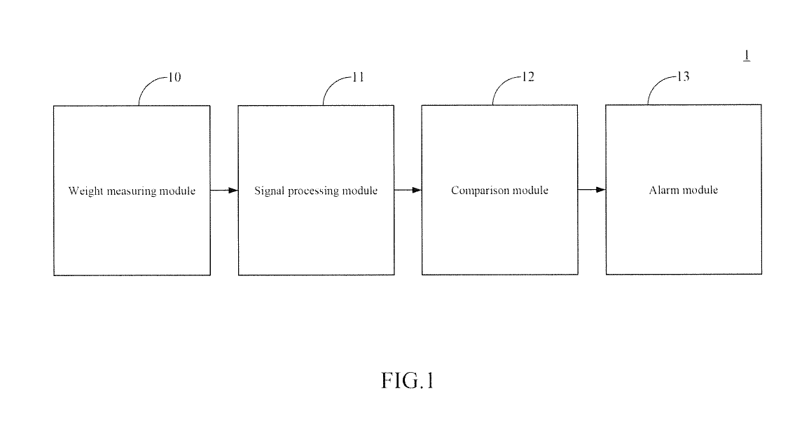

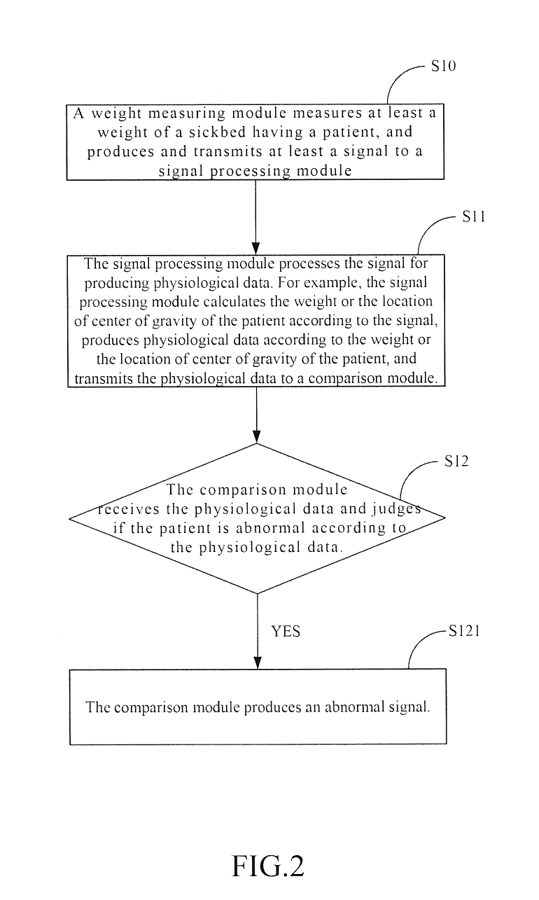

FIG. 1 and FIG. 2 show a system block diagram and a flowchart according to a first embodiment of the present invention. As shown in the figures, the present invention provides an intelligent weight monitoring system 1 used for monitoring the status of a patient lying on a sickbed and judging the status of the patient by means the weight variation of the patient. The intelligent weight monitoring system 1 comprises a weight measuring module 10, a signal processing module 11, and a comparison module 12. The monitoring method of the intelligent weight monitoring system 1 is first to execute the step S10, which uses the weight measuring module 10 to measure at a weight of the sickbed having the patient for producing a least a signal; the weight measuring module 10 then transmits the signal to the signal processing module 11. The signal processing module 11 can be an electronic device disposed on one side of the sickbed. Next, the step S11 is executed, in which step the signal processing module 11 processes the signal for producing physiological data. For example, the signal processing module 11 calculates the patient's weight or center of gravity according to the signal, and produces and transmits physiological data according to the patient's weight or center of gravity to the comparison module 12. The comparison module 12 according to the present embodiment is a server. Finally, the step S12 is executed, in which step the comparison module 12 receives the physiological data and judges if the patient is abnormal according to the physiological data. When the comparison module 12 judges that the patient is abnormal, the step S121 is executed, in which step the comparison module 12 produces an abnormal signal. The patient's family members or nurses can get the abnormal signal produced by the comparison module real-timely and thus resolving the abnormal condition of the patient according to the abnormal signal.

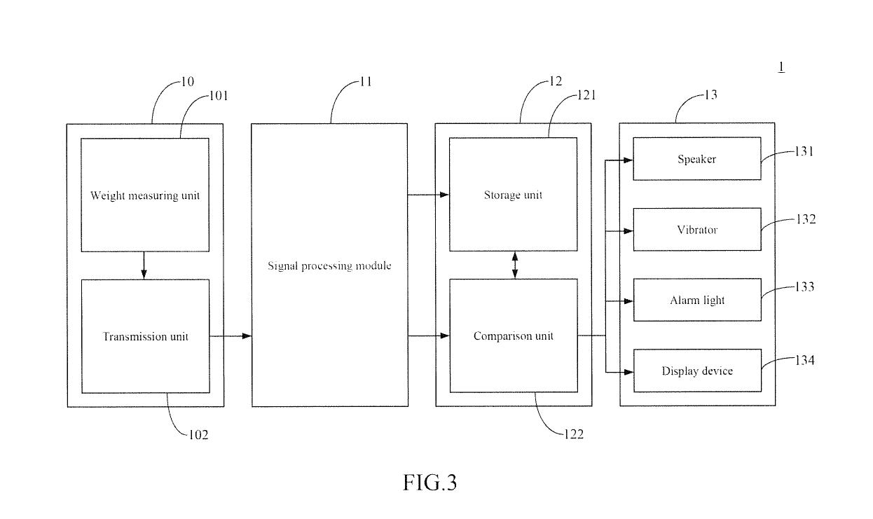

FIG. 3 shows an elaborate block diagram according to the first embodiment of the present invention. As shown in the figure, the weight measuring module 10 described above comprises a weight measuring unit 101 and a transmission unit 102. The weight measuring unit 101 measures the weight of the sickbed and the patient and produces a signal according to the measured weight. Then the weight measuring unit 101 transmits the signal to the transmission unit 102 using wired or wireless transmission. Afterwards, the transmission unit 102 transmits the signal to the signal processing module 11. According to the present embodiment, the transmission unit 102 transmits the signal to the signal processing module 11 using wireless transmission. Of course, the transmission between the transmission unit 102 and the signal processing module 11 can be wired. The details will not be described further.

After the signal processing module 11 receives the signal, the signal processing module 11 starts to process the signal, namely, the step S11 shown in FIG. 2, and calculates the patient's current weight according to the signal. Then it extracts the weight recorded in the signal minus the weight of the sickbed. Afterwards, the signal processing module 11 arranges the patient's current weight as the physiological data. Next, the signal processing module 11 transmits the physiological data to the comparison module 12, which receives the physiological data. The comparison module 12 includes a storage unit 121 and a comparison unit 122. When the signal processing module 11 transmits the physiological data to the comparison module 12, the storage unit 121 and the comparison unit 122 receive the physiological data simultaneously. The storage unit 121 stores the physiological data. Besides, nursing personnel can build the basic information of patients in the storage unit 121 for convenient inquire in the later time. When the comparison module 12 receives the physiological data, as the step S12 in FIG. 2, the comparison unit 122 of the comparison module 12 can configure at least a parameter. According to the present embodiment, the parameter is an appropriate weight range. In other words, the minimum and the maximum values of an appropriate weight are configured. This weight range is determined according to the physiological status (disease) of the patient. When the comparison unit 122 receives the physiological data, it extracts the patient's current weight recorded in the physiological data and judges if the patient's current weight exceeds the weight range configured beforehand.

When the comparison unit 122 judges that the patient's current weight is far below the minimum value of the weight range, the patient may be absent from the sickbed; when the patient's current weight is below the minimum value of the weight range, the patient may be dehydrated; when the patient's current weight is above the maximum value of the weight range, the patient may have edema. No matter below the minimum value or above the maximum value, once the patient's current weight goes beyond this weight range, it means that the patient's status is abnormal. When the comparison unit 122 judges that the patient's status is abnormal, the comparison unit 122 produces an abnormal signal according to the judgment result, as the step S121 in FIG. 2, and transmits the abnormal signal to an alarm module 13. The alarm module 13 can be speaker 131, a vibrator 132, an alarm light 133, or a display device 134 usually disposed on bedside, the door of a ward, or the nursing station. When the alarm module 13 receives the abnormal signal transmitted by the comparison unit 122, the alarm module 13 produces an alarm signal, which can be expressed in the forms of text, images, voice, vibration, or flashes. Thereby, the family members besides the sickbed or the nurses outside the ward can see the alarm signal and the medical measures can be performed on the patient immediately.

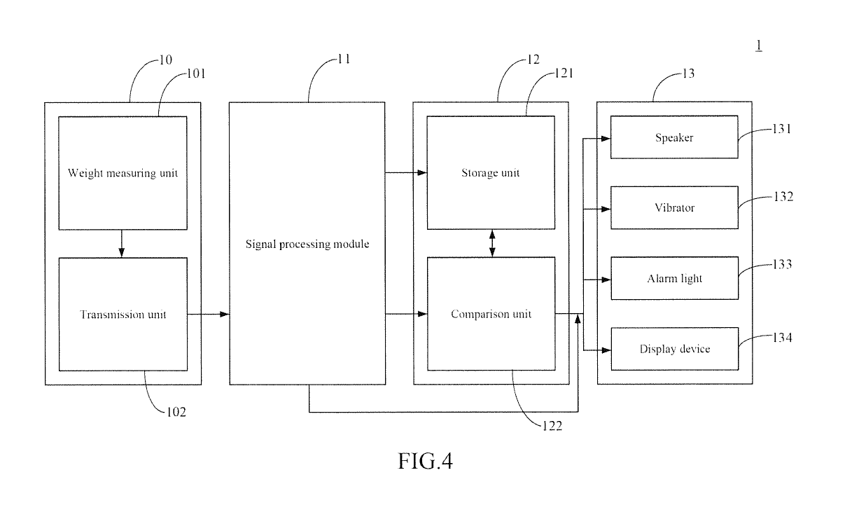

FIG. 4 shows a system block diagram according to a second embodiment of the present invention. As shown in the figure, according to the above embodiment, the comparison unit 122 can judge if the patient is absent from the sickbed. According to the present embodiment, another method for judging if the patient is absent form the sickbed is provided. When the weight measuring module 10 measure the patient's weight at first time, it produces and transmits a first signal to the signal processing module 11. The signal processing module 11 processes the first signal, and produces and transmits first physiological data to the comparison module 12. The comparison module 12 judges that the patient's weight at the first time falls within the weight range according to the first physiological data.

After confirming that the patient's weight at the first time falls within the weight range, the first signal is used as the baseline for comparison. When the weight measuring module 10 measures the patient's weight at second time, it produces and transmits a second signal to the signal processing module 11. The signal processing module 11 calculates the difference between the second and the first signals. When the difference is excessively large, it means that the difference between the weight measured at the second time by the weight measuring module 10 and the one measured at the first time is excessively large. When the difference is just the patient's weight, it means that the patient may fall to the ground and is thus absent from the sickbed. At this moment, the signal processing module 11 produces an abnormal signal directly and transmits it to the alarm module 13. The alarm module 13 produces an alarm signal for notifying the patient's family members or the nurses of checking.

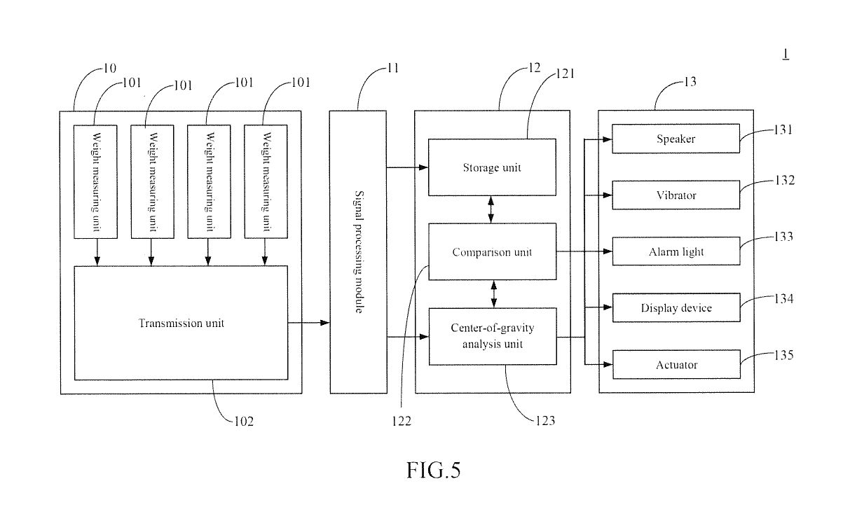

FIG. 5 shows a system block diagram according to a third embodiment of the present invention. As shown in the figure, the weight measuring module 10 according to the present embodiment has four weight measuring units 101 disposed at the four corners of the sickbed and producing a signal according to the weight they bear, respectively. Then the weight measuring units 101 transmit the signals to the transmission unit 102. The transmission unit 102, in turn, transmits the signal to the signal processing module 11. The signal processing module 11 starts to process the signals and calculate the patient's current weight and the current location of center of gravity according to the signals. Next, the signal processing module 11 arranges the patient's current weight and the current location of center of gravity as the physiological data. In addition, for acquiring the patient's location of center of gravity accurately, more weight measuring units 101 can be disposed uniformly over the sickbed. The details will not be described further.

Afterwards, the signal processing module 11 transits the physiological data to the comparison module 12; the comparison module 12 receives the physiological data. The comparison module 12 further includes a center-of-gravity analysis unit 123. When the signal processing module 11 transmits the physiological data to the comparison module 12, the physiological data can be stored in the storage unit 121. The center-of-gravity analysis unit 123 first sets a danger zone for center of gravity. Meanwhile, center-of-gravity analysis unit 123 extracts the patient's current location of center of gravity recorded ion the physiological data and judges if the patient's current location of center of gravity is located in the danger zone for center of gravity. The danger zone for center of gravity is configured according to each patient's physiological condition. Each patient's danger zone for center of gravity can be stored in the storage unit 121. When the center-of-gravity analysis unit 123 performs analysis later, it can be read from the storage unit 121 directly.

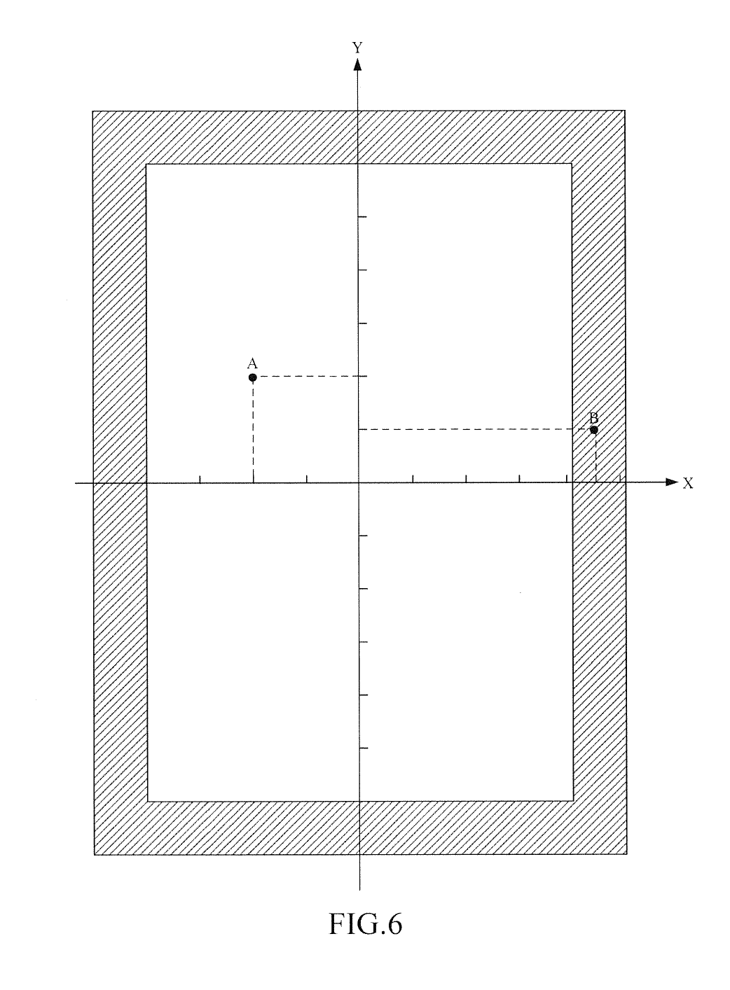

FIG. 6 shows a schematic diagram of the danger zone for center of gravity according to the third embodiment of the present invention. As shown in the figure, the shaded area is just the danger zone for center of gravity. If the patient's current location of center of gravity is the point A, which is not located in the danger zone for center of gravity, it means that the current status of the patient is normal and the center-of-gravity analysis unit 123 will not produce the abnormal signal. If the patient's current location of center of gravity is the point B, which is located in the danger zone for center of gravity, it means that the current status of the patient is abnormal. The center-of-gravity analysis unit 123 will produce and transmit the abnormal signal to the alarm module 13. The alarm module 13 will produce the alarm signal for notifying the patient's family members or the nurses of checking.

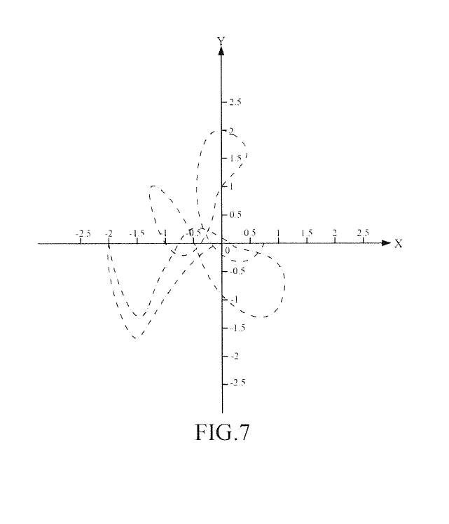

FIG. 7 shows a schematic diagram of the distribution data for center of gravity according to the third embodiment of the present invention. As shown in the figure, the weight measuring module 10 measures for every time interval. The signal processing module 11 processes for producing the physiological data of the patient's location of center of gravity in each time interval. The center-of-gravity analysis unit 123 receives the physiological data in each time interval, and records the patient's location of center of gravity in each time interval according to the physiological data for producing center-of-gravity analysis data. The center-of-gravity analysis unit 123 transmits the center-of-gravity analysis data to the comparison unit 122, which can set at least a time range. The distribution data for center of gravity is compared to the time range. In the time range, whether the patient's locations of center of gravity are the same is judged. If so, it means that the patient is not turned for a long time, which may lead to bedsore. Thereby, this status is abnormal. The comparison unit 122 produces and transmits the abnormal signal to the alarm module 13. According to the present embodiment, the alarm module 13 further includes an actuator 135, for example, a percussion device or a turn device. The alarm module 13 then percusses or turns the patient according to the abnormal signal. Of course, the alarm module 13 can also produces the alarm signal for notifying the patient's family members or the nurses of checking. Moreover, by comparing the distribution data for center of gravity to the time range using the comparison unit 122, the variation of the patient's location of center of gravity in the time range is given. Hence, the number of turns for the patient can be known and thus knowing the patient's sleep quality.

To sum up, the present invention provides an intelligent weight monitoring system and the method thereof mainly used for monitoring the status on a sickbed. By using the intelligent weight monitoring system, the variations in weight and in the location of center of gravity of a patient can be monitored real-timely. Accordingly, whether the patient falls outside the sickbed due to turning or whether the patient is dehydrated or has edema, as well as the number of turns, the sleep quality, or other physiological conditions, can be known. When the intelligent weight monitoring system judges that the patient is in the abnormal status, an alarm signal is produced immediately for notifying the patient's family members or the nurses of checking. Thereby, real-time and appropriate medical measures can be applied.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An intelligent weight monitoring system, comprising:
a weight measuring module, measuring at least a weight of a sickbed having a patient, and producing and transmitting at least a signal according to said weight;
a signal processing module, receiving and processing said signal for producing and transmitting a physiological data; and
a comparison module, receiving said physiological data and judging if said patient is abnormal according to said physiological data for producing an abnormal signal.

2. The intelligent weight monitoring system of claim 1, and further comprising an alarm module, receiving said abnormal signal, and producing an alarm signal according to said abnormal signal.

3. The intelligent weight monitoring system of claim 1, wherein said weight measuring module comprises:
at least a weight measuring unit, measuring said weight of said sickbed having said patient, and producing said signal according to said weight measured by said weight measuring unit; and
at least a transmission unit, connecting to said weight measuring unit, recessing and transmitting said signal to said signal processing module.

4. The intelligent weight monitoring system of claim 1, wherein said signal processing module calculates a difference between said signal and another signal, and produces said abnormal signal according said difference.

5. The intelligent weight monitoring system of claim 1, wherein said signal processing module calculates a weight or a location of center of gravity of said patient according to said signal, and produces said physiological data according to said weight or said location of center of gravity of said patient.

6. The intelligent weight monitoring system of claim 1, wherein said comparison module comprises:
a storage unit, receiving and storing said physiological data transmitted by said signal processing module; and
a comparison unit, receiving said physiological data, configuring at least a parameter, and comparing said parameter to said physiological data.

7. The intelligent weight monitoring system of claim 6, wherein said signal processing module calculates a weight or a location of center of gravity of said patient according to said signal, and produces said physiological data according to said weight or said location of center of gravity of said patient.

8. The intelligent weight monitoring system of claim 7, wherein said parameter is a weight range, and said comparison unit compares if said patient's weight recorded in said physiological data exceeds said weight range for producing said abnormal signal.

9. The intelligent weight monitoring system of claim 7, wherein said comparison module further comprises a center-of-gravity analysis unit, setting a danger zone for center of gravity, receiving said physiological data, recording said location of center of gravity of said patient according to said physiological data, and judging if said location of center of gravity of said patient falls in said danger zone for center of gravity for producing said abnormal signal.

10. The intelligent weight monitoring system of claim 9, wherein said center-of-gravity analysis unit records said location of center of gravity of said patient for producing distribution data for center of gravity, and transmits said distribution data for center of gravity to said comparison unit.

11. An intelligent weight monitoring method, comprising steps of:
providing a weight measuring module;
said weight measuring module measuring at least a weight of a sickbed having a patient, and producing and transmitting at least a signal to a signal processing module according to said weight;
said signal processing module calculating the location of center of gravity of said patient, producing physiological data according to said location of center of gravity of said patient, and transmits said physiological data to a comparison module; and
said comparison module judging if said patient is abnormal according to said physiological data for producing an abnormal signal.

12. The intelligent weight monitoring method of claim 11, wherein said step of said comparison module judging if said patient is abnormal according to said physiological data comprises steps of:
said comparison module recording said location of center of gravity of said patient recorded in said physiological data and producing distribution data for center of gravity;
said comparison module configuring at least a parameter, and said parameter being a time range; and
said comparison module judging if said locations of center of gravity of said patient recorded in said distribution data for center of gravity in said time range are the same for producing said abnormal signal.

13. The intelligent weight monitoring method of claim 11, wherein said step of said comparison module judging if said patient is abnormal according to said physiological data comprises steps of:
said comparison module recording said location of center of gravity of said patient recorded in said physiological data and producing distribution data for center of gravity;
said comparison module configuring at least a parameter, and said parameter being a time range; and
said comparison module judging the number of variations of said locations of center of gravity of said patient recorded in said distribution data for center of gravity in said time range.

14. The intelligent weight monitoring method of claim 11, wherein said step of said comparison module judging if said patient is abnormal according to said physiological data comprises steps of:
said comparison module setting a danger zone for center of gravity; and
said comparison module judging if said location of center of gravity of said patient recorded in said physiological data is in said danger zone for center of gravity for producing said abnormal signal.
